(19) United States
(12) Patent Application Publication
(10) Pub. No.: US 2003/0076036 A1
(43) Pub. Date: Apr. 24, 2003

(54) System for attaching a filament to a current lead-in

(76) Inventor: Jean-Paul Charlier, Eply (FR)

Correspondence Address: U.S. Philips Corporation, 580 White Plains Road, Tarrytown, NY, 10591, US

(21) Appl. No.: 10/277,588

(22) Filed: Oct. 22, 2002

(30) Foreign Application Priority Data
Oct. 23, 2001 (FR) 0113671

(51) Int. Cl. H01K 1/02

(52) U.S. Cl. 313/578; 313/341

(57) ABSTRACT

The invention relates to the field of lamps. An electric incandescent lamp comprises a filament comprising a portion (100) comprising coils disposed in a spiral around an axis of revolution (110), and a secondary part (102) connected to said portion by means of a spacer (104), as well as a metal current supply rod (106), the secondary part being attached to the metal rod by means of the spacer. In order to facilitate the assembly of such a filament in the lamp, that is to say the attachment of the filament to the metal supply rod, the spacer comprises at least two coils stretched in a direction parallel to the axis of revolution of said portion.

### TECHNICAL FIELD

The invention relates to an electrical incandescent lamp comprising at least:

a filament comprising at least one portion comprising coils disposed in a spiral around an axis of revolution, and a secondary part connected to said portion by means of a spacer; and

a metal current supply rod, the secondary part being attached to the metal rod by means of the spacer.

Such a lamp finds its application, for example, in a stage lighting system.

### PRIOR ART

Such a lamp is sold by the applicant under the reference 6995Z. In such a lamp, the filament is composed of several portions disposed in two planes. Two metal rods electrically connected to two of the filament portions and to an external electrical circuit enable the lamp to be supplied with current. These two metal rods have at one end a hook oriented about an axis of revolution and are electrically connected to the two portions by means of two spacers which are inserted in the hooks on the metal rods. Each spacer is thus in contact with the hook of a metal supply rod at an attachment point dependent on a curvature of the spacer.

Such a spacer is obtained by the momentary interruption of a coiling process for making the turns of the filament, while the filament is being manufactured. This interruption in the coiling process is a tricky operation which results in a random curvature of the spacer, that is to say the attachment point may be situated either to the left or to the right of the axis of revolution of the hook on the metal rod. However, the applicant has found that, during an operation of assembling the filament and the metal current supply rods, inserting the spacer in the hook of a metal rod is particularly difficult if the attachment point is situated on a certain side of the axis of revolution of the hook, and easier if the attachment point is situated on the other side, this side depending on an orientation of the hook.

However, in a lamp of the type sold under the reference 6995Z, the two metal supply rods are symmetrical. Consequently, when the attachment point of a spacer is situated on one side of the axis of revolution of the hook to which it is connected and the attachment point of the other spacer is situated on the other side of the axis of revolution of the hook to which it is connected, assembling the filament in the lamp is difficult.

However, even if the two supply rods are asymmetrical, a similar problem arises when the two attachment points are situated on the same side of the two axes of revolution of the hooks on the metal supply rods.

Such a situation gives rise to a relatively long assembly time and to risks of breakage of the filament.

### SHORT DESCRIPTION OF THE INVENTION

It is an object of the invention to facilitate the assembly of a filament in an incandescent lamp.

According to the invention, an electric incandescent lamp as defined in the opening paragraph is characterized in that the spacer comprises at least two coils stretched in a direction parallel to the axis of revolution of the portion.

The term ‘stretched’ means that the coils of the spacer have between them a greater spacing than a spacing of the coils of the portion or of the secondary part. For example, the spacing between two coils of the portion may be 0.2 mm and the spacing between two coils on the spacer 2 mm.

The spacer, comprising at least two coils, has at least two possible attachment points on the metal current supply rod. At least one of these attachment points is situated on one side of the axis of revolution of the hook to which the spacer is connected, so that inserting the spacer into the hook is easy. Thus the assembly of the filament in the lamp is facilitated.

The invention also facilitates the assembly of a filament in a lamp of the type sold by the applicant under the reference 6885Z and described in the prior art. This is because, if only one of the two spacers comprises at least two coils, a positioning step makes it possible to position the other spacer, during the lamp assembly operation, such that its attachment point is situated on one side of the axis of revolution of the hook to which it is connected, so that inserting the spacer in the hook is easy. The spacer comprising at least two coils will then necessarily have at least one attachment point situated on the side of the axis of revolution of the hook to which it is connected, so that inserting the spacer into the hook is easy. Consequently, the assembly of the filament in the lamp is facilitated. If the two spacers comprise at least two coils, they each necessarily have at least one attachment point situated on the side of the axis of revolution of the hook to which they are connected, so that inserting the spacer into the hook is easy. Consequently, the assembly of the filament in the lamp is facilitated in such a case and does not require the placement step necessary if only one spacer comprises at least two coils. Such a reasoning is valid both for symmetrical and asymmetrical metal supply rods.

### BRIEF DESCRIPTION OF THE FIGURES

The invention will be further described with reference to embodiments shown in the drawings to which, however, the invention is not restricted.

FIGS. 1a and 1b are a front view and a left-hand view of a lamp according to the prior art, respectively;

FIGS. 2a and 2b are a front view and a left-hand view of a lamp according to a first embodiment of the invention, respectively;

FIGS. 3a and 3b are a front view and a left-hand view of a lamp according to a second embodiment of the invention, respectively.

### DETAILED DISCLOSURE OF AT LEAST ONE EMBODIMENT OF THE INVENTION

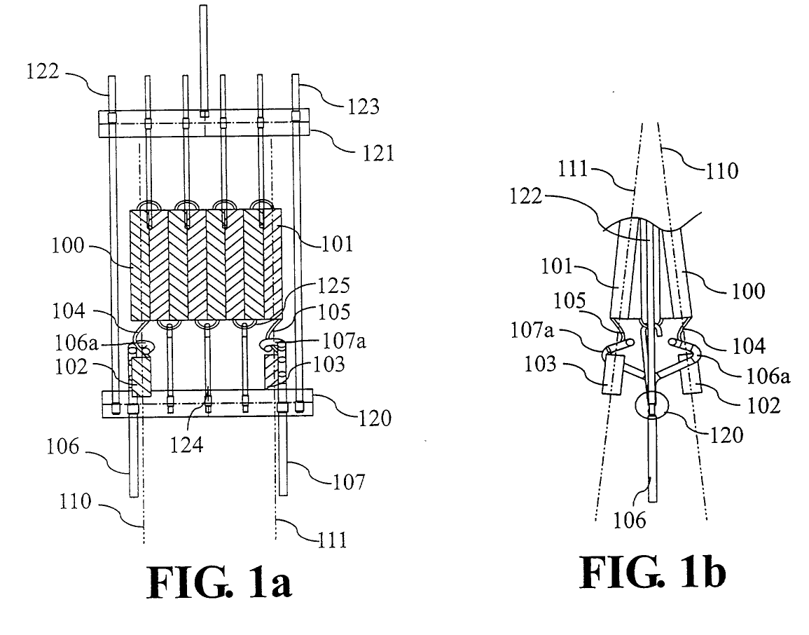

FIGS. 1a and 1b illustrate a lamp of the prior art. A description of such a lamp gives an understanding of a problem resolved by the invention.

Such a lamp comprises a first filament portion 100, a second filament portion 101, a first secondary part 102, a second secondary part 103, a first spacer 104, a second spacer 105, a first metal supply rod 106 comprising a first hook 106a, a second metal supply rod 107 comprising a second hook 107a, bridges 120 and 121 connected by metal bars 122 and 123, spacers 124, and filament loops 125. The first portion 100 has a first axis of revolution 110, the second portion 101 has a second axis of revolution 111. The axes of revolution of the hooks 106a and 107a coincide substantially with the first axis of revolution 110 and the second axis of revolution 111. It will be considered below that the axis of revolution of the first hook 106a is the first axis of revolution 110 and that the axis of revolution of the second hook 107a is the second axis of revolution 111. The filament comprises four portions situated at the front of a plane defined by the spacers 124. The first portion 100 is one of these four portions. The filament also comprises four portions situated at the rear of a plane defined by the spacers 124. The second portion 101 is one of these four portions.

In order to manufacture such a filament, a tungsten wire is wound in order to obtain the first secondary part 102. The coiling process is then interrupted in order to obtain the first spacer 104, then resumed in order to obtain a long helical part, then once again interrupted in order to obtain the second spacer 105 and finally resumed in order to obtain the second secondary part 103. The long helical part is then folded into eight portions separated by loops 125, and the filament thus obtained undergoes a heat treatment intended to stabilize such a configuration in portions. In order to electrically connect the first portion 100 and the first metal rod 106, all that would have to be done is to insert one of the coils of the first portion 100 in the first hook 106a. However, the heat treatment has a tendency to weaken the filament, so that such an operation might break the filament. This is why the first spacer 104 is necessary. The same applies to the second spacer 105.

However, the first and second spacers 104 and 105 are manufactured such that they have a random curvature. If this curvature is towards the left with respect to the axis of revolution of the hook to which the spacer is connected, as is the case with the first spacer 104, inserting the first spacer 104 into the first hook 106a is easy. This is because it suffices to place the first spacer 104 and the first secondary part 102 to the right of the first hook 106a, to offset the first spacer 104 towards the front, and then towards the left and finally towards the rear so that it is inserted into the first hook 106a.

During such an operation, the first secondary part 102 does not hit against the first metal rod 106. However, if the curvature of a spacer is towards the right with respect to the axis of revolution of the hook to which the spacer is connected, as is the case with the second spacer 105, inserting the second spacer 105 into the second hook 107a is difficult. This is because, when the second spacer is offset towards the left, that is to say towards the right in FIG. 1a or towards the rear in FIG. 1b, the second secondary part 103 will hit against the second metal rod 107. Thus, in order to insert the second spacer 105 into the second hook 107a, it is necessary to apply additional force to the second spacer 105, which risks breaking this second spacer 105.

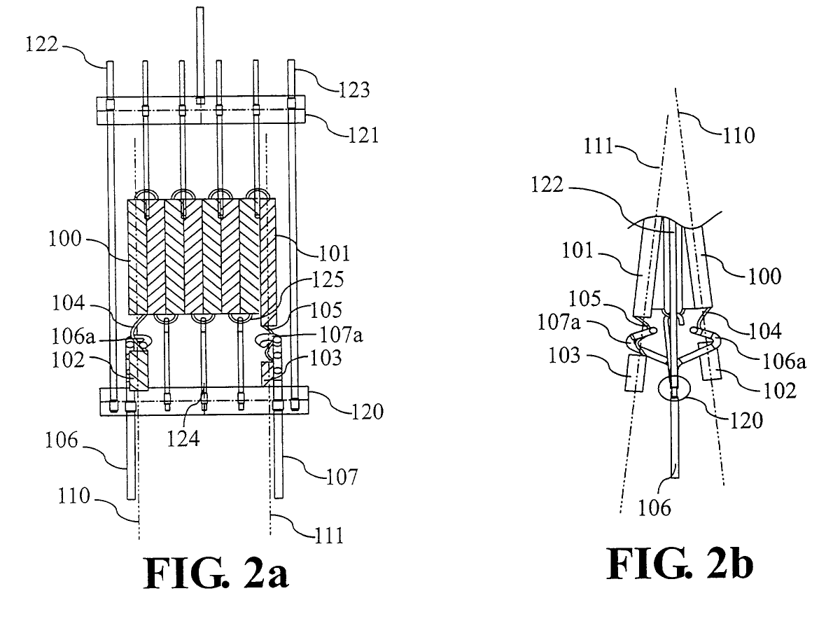

FIGS. 2a and 2b illustrate a lamp according to a first embodiment of the invention. Such a lamp comprises elements identical to those described in the description of FIGS. 1a and 1b. However, in this first embodiment, one of the two spacers comprises at least two coils stretched in a direction parallel to the axis of revolution of the portion to which it is connected. In the example depicted in FIGS. 2a and 2b, the second spacer 105 comprises two coils stretched along the second axis of revolution 111. Such stretching may be achieved by applying a traction force directed along the second axis of revolution 111 to the long helical part obtained by coiling of the tungsten wire. This force is applied before the heat treatment so as to obtain the second spacer 105 composed of two filament coils, one to the left, the other to the right of the second axis of revolution 111. It may be applied before or after folding of the long helical part.

Such a stretching may also be obtained by modifying the coiling process adjacent the second spacer 105. This is because it is possible during coiling to adjust a separation between two consecutive coils of the filament. It is therefore possible to define a greater separation for the two coils constituting the second spacer 105.

In the example illustrated in FIGS. 2a and 2b, the filament is inserted into the lamp as follows. A placement step first of all makes it possible to insert the first spacer 104 into the hook for which insertion is easy. In this example, the attachment point of the spacer 104 being situated to the left of the axis of revolution of the first hook 106a and to the right of the axis of revolution of the second hook 107a, the first spacer 104 is inserted into the first hook 106a since this insertion is easy, as explained in the description of FIGS. 1a and 1b. The second spacer 105 now necessarily having an attachment point situated to the left of the axis of revolution of the second hook 107a, inserting it into this second hook 107a is also easy.

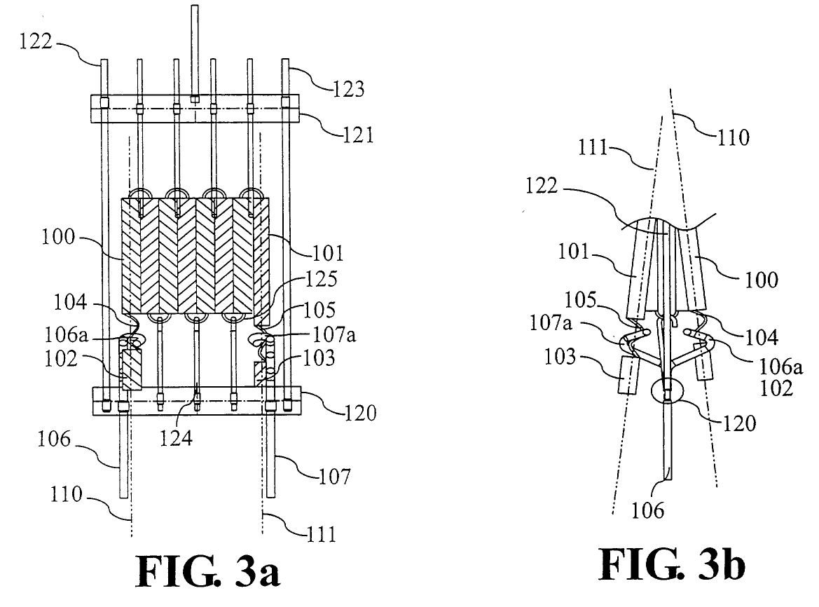

FIGS. 3a and 3b illustrate a lamp according to a second embodiment of the invention. Such a lamp comprises elements identical to those described in the description of FIGS. 1a and 1b. However, in this second embodiment, the two spacers comprise at least two coils stretched in a direction parallel to the axis of revolution of the portion to which they are connected. Such a stretching is achieved as described in the description of FIGS. 2a and 2b.

In the example depicted in FIGS. 3a and 3b, the two spacers 104 and 105 each comprise two coils stretched along the axes of revolution 110 and 111. Each of the spacers 104 and 105 comprises an attachment point situated on one side of the axis of revolution of the hook to which it is connected, so that inserting the spacer in the hook is easy. Thus inserting the filament in the lamp is easy, and the placement step necessary in the lamp illustrated in FIGS. 2a and 2b is unnecessary.

The above description with reference to the Figures illustrates the invention rather than limiting it. In this regard, a few remarks are made below. FIGS. 2a to 3b illustrate examples of embodiments of the invention. The filament used is a tungsten filament obtained by coiling of a tungsten wire. Obviously, other materials may be used for manufacturing such a filament, provided that these materials emit light when an electric current passes through them.

In FIGS. 2a and 2b, the filament shown has several portions with substantially equivalent lengths, disposed in two planes. It is obviously possible, without departing from the spirit of the invention, to use filaments having different configurations, for example filaments comprising a different number of portions, for example a single portion, or lengths of portions different from one portion to another.

FIGS. 1a to 3c illustrate a lamp having two metal supply rods comprising a hook. The invention also applies to a lamp having a different number of metal supply rods comprising a hook, notably a lamp comprising a filament of which one end is welded to a metal rod and the other end is attached to another metal supply rod by means of an attachment system like the one described in the invention.

1. An electric incandescent lamp comprising at least:
a filament comprising at least one portion (100) comprising coils disposed in a spiral around an axis of revolution (110), and a secondary part (102) connected to said portion by means of a spacer (104); and
a metal current supply rod (106), the secondary part being attached to the metal rod by means of the spacer;
said lamp being characterized in that the spacer comprises at least two coils stretched in a direction parallel to the axis of revolution of said portion.
